(19) United States
(12) Patent Application Publication
(10) Pub. No.: US 2023/0009111 A1
(43) Pub. Date: Jan. 12, 2023

(54) SYSTEMS AND METHODS FOR LINKED PROGRESSIVE SPINS IN ELECTRONIC GAMING

(71) Applicant: Aristocrat Technologies, Inc., Las Vegas, NV (US)

(72) Inventors: Daniel Marks, Decatur, GA (US); Hua Xu, Marietta, GA (US); Dinesh Dua, Alpharetta, GA (US); Haolin Ma, Johns Creek, GA (US); Nan Lu, Marietta, GA (US); T. Grant Bolling, JR., Maryland Heights, MO (US)

(21) Appl. No.: 17/854,390

(22) Filed: Jun. 30, 2022

Related U.S. Application Data
(60) Provisional application No. 63/220,915, filed on Jul. 12, 2021.

(51) Int. Cl. G07F 17/32

(52) U.S. Cl. CPC G07F 17/3267; G07F 17/3213; G07F 17/34

(57) ABSTRACT

An electronic gaming system including a plurality of electronic gaming devices and a progressive controller in communication with the plurality of electronic gaming devices is described. The progressive controller causes display of a number of linked progressive free spins at each electronic gaming device of the plurality of electronic gaming devices and determines, during an electronic game, that a progressive symbol is displayed on a display device of at least one electronic gaming device of the plurality of electronic gaming devices. The progressive controller also causes the number of linked progressive free spins to be increased to an updated number of linked progressive free spins and, based upon the updated number of linked progressive free spins, causes display of the updated number of linked progressive free spins at each electronic gaming device of the plurality of electronic gaming devices.

### CROSS REFERENCE TO RELATED APPLICATIONS

This application claims the benefit of priority to U.S. Provisional Pat. Application No. 63/220,915, filed Jul. 12, 2021, the contents of which are incorporated herein by reference in their entirety.

### TECHNICAL FIELD

The field of disclosure relates generally to electronic gaming, and more specifically, to systems and methods for linked progressive spins in electronic gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is described. The electronic gaming system includes a plurality of electronic gaming devices wherein each electronic gaming device of the plurality of electronic gaming devices includes a display device, and a progressive controller in communication with the plurality of electronic gaming devices wherein the progressive controller includes at least one processor and at least one memory device wherein the at least one memory device includes computer-executable instructions stored thereon. The instructions cause the at least one processor to cause display of a number of linked progressive free spins at each electronic gaming device of the plurality of electronic gaming devices wherein the number of linked progressive free spins is stored in the at least one memory device and associated with a plurality of sets of paytables stored in the at least one memory device and wherein each electronic gaming device of the plurality of electronic gaming devices is eligible to present the number of linked progressive free spins during play of an electronic game. The instructions also cause the at least one processor to determine, during the electronic game, that a progressive symbol is displayed on a display device of at least one electronic gaming device of the plurality of electronic gaming devices and based upon determining that the progressive symbol is displayed, cause the number of linked progressive free spins to be increased to an updated number of linked progressive free spins. The instructions further cause the at least one processor to, based upon the updated number of linked progressive free spins, cause display of the updated number of linked progressive free spins at each electronic gaming device of the plurality of electronic gaming devices wherein each electronic gaming device of the plurality of electronic gaming devices is eligible to present the updated number of linked progressive free spins during play of a feature game.

In another aspect, a non-transitory computer-readable storage medium with instructions stored thereon is described. The instructions, in response to execution by at least one processor, cause the at least one processor to cause display of a number of linked progressive free spins at each electronic gaming device of a plurality of electronic gaming devices wherein the number of linked progressive free spins is stored in a memory device and associated with a plurality of sets of paytables stored in the memory device and wherein each electronic gaming device of the plurality of electronic gaming devices is eligible to present the number of linked progressive free spins during play of an electronic game. The instructions also cause the at least one processor to determine, during the electronic game, that a trigger symbol is displayed on a display device of at least one electronic gaming device of the plurality of electronic gaming devices and based upon determining that the trigger symbol is displayed, cause the number of linked progressive free spins to be increased to an updated number of linked progressive free spins in the memory device. The instructions further cause the at least one processor to, based upon the updated number of linked progressive free spins, cause display of the updated number of linked progressive free spins at each electronic gaming device of the plurality of electronic gaming devices, wherein each electronic gaming device of the plurality of electronic gaming devices is eligible to present the updated number of linked progressive free spins for play of a feature game.

In yet another aspect, a method of electronic gaming implemented by at least one processor in communication with at least one memory device is described. The method includes causing display of a number of linked progressive free spins at each electronic gaming device of a plurality of electronic gaming devices wherein the number of linked progressive free spins is stored in the at least one memory device and associated with a plurality of sets of paytables stored in the at least one memory device and wherein each electronic gaming device of the plurality of electronic gaming devices is eligible to present the number of linked progressive free spins during play of an electronic game. The method also includes determining, during the electronic game, that a trigger symbol is displayed on a display device of at least one electronic gaming device of the plurality of electronic gaming devices and based upon determining that the trigger symbol is displayed, causing the number of linked progressive free spins to be increased to an updated number of linked progressive free spins in the at least one memory device. The method further includes, based upon the updated number of linked progressive free spins, causing display of the updated number of linked progressive free spins at each electronic gaming device of the plurality of electronic gaming devices, wherein each electronic gaming device of the plurality of electronic gaming devices is eligible to present the updated number of linked progressive free spins during play of a feature game.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an example diagram of a progressive controller in communication with a plurality of electronic gaming devices, as described herein.

FIGS. 5A, 5B, and 5C are example screenshots of a sequence of an electronic game including a linked progressive, as described herein.

FIG. 6 is an example portion of the screenshot shown in FIG. 5A.

FIG. 7 is an example method of electronic gaming including a linked progressive, as described herein.

### DETAILED DESCRIPTION

Systems and methods for electronic gaming including a plurality of feature levels and a plurality of corresponding progressive play meters that may be controlled and displayed during the electronic game are described herein. In the example embodiment, a progressive controller including at least one processor and at least one memory is configured to control at least one progressive play meter (e.g., a number of shared/linked free spins) that is shared/linked across a plurality of electronic gaming devices. For example, at least one number of linked free spins may be increased in response to a trigger condition (e.g., a certain symbol being displayed) occurring at any electronic gaming device of the plurality of electronic gaming devices. Further, the linked free spins may be presented at any electronic gaming device of the plurality of electronic gaming devices (e.g., for a feature game).

Known systems may provide a shared progressive jackpot amount across a plurality of EGMs. However, those known systems are limited to sharing a scalable prize amount (e.g., a progressive jackpot amount) across a plurality of EGMs. Known progressive jackpot amounts shared across EGMs may include different amounts shown at different EGMs based upon different wager amounts being placed at different EGMs. This may be undesirable at least because certain players desire a shared progressive that is the same at each electronic gaming device (e.g., regardless of wager/input amount). Accordingly, the systems and methods described herein provide a progressive controller configured to control a shared progressive that is the same at each electronic gaming device (e.g., the same amount of free spins are eligible to be presented at each electronic gaming device) in communication with the progressive controller.

Certain technical problems arise when configuring a progressive controller to control a shared progressive that is consistent across a plurality of electronic gaming devices (e.g., wherein other progressives that are not shared may also be included). For example, typical/known progressives available to be presented during an electronic game may be dependent upon a wager amount at the gaming device (e.g., the progressive amount available scales up or down as the wager amount goes up or down to control RTP). Here, in the example embodiment, the progressive controller described herein is configured to achieve a shared progressive solution by controlling a shared progressive to consistently increase and/or decrease (e.g., be reset) across a plurality of gaming devices while also controlling other progressives at the gaming devices that may vary by wager amount.

However, RTP still needs to be controlled in the example game described herein despite the shared progressive being consistent across all participating gaming devices. Accordingly, the progressive controller described herein provides a solution by being configured to control RTP at each of the gaming devices in communication with the progressive controller with respect to outcomes of the shared number of free spins. For example, while each participating gaming device is eligible to win the same number of free spins, once the free spins are presented at a particular gaming device (e.g., for a feature game), the outcome(s) of the free spins may vary based upon wager amount at the particular gaming device. Thus, while each gaming device is eligible to win the same number of free spins (e.g., shared progressive), the outcome of the free spins, once presented/played, may be controlled based upon wager amount in order to control RTP (e.g., different paytables may be utilized based upon wager amount to determine a total outcome of the number of free spins- despite the number of free spins presented being consistent regardless of wager amount).

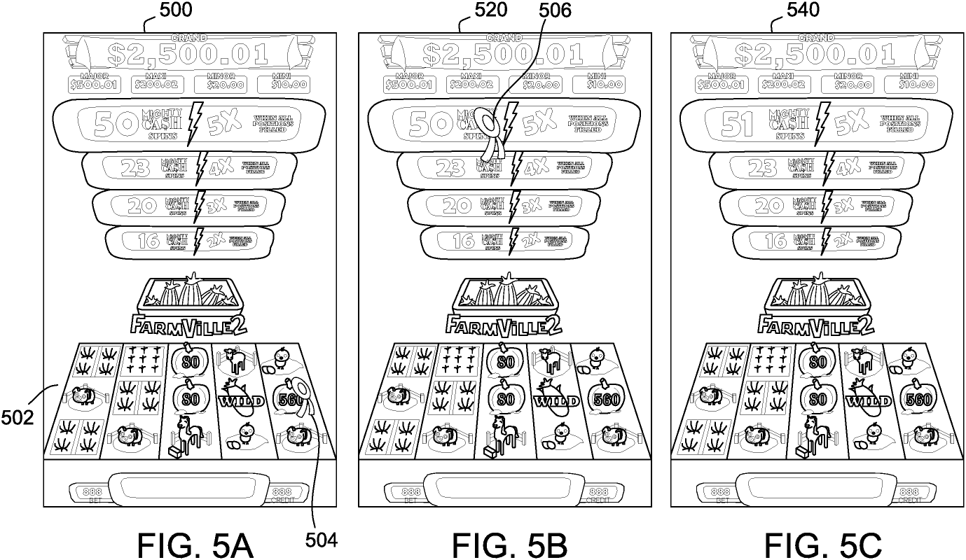

Further, certain display improvements are provided herein. For example, certain animations may be controlled to move from a first display area (e.g., including reels and/or symbol positions) to a second display area (e.g., including progressive meters) in order to indicate which progressive will be presented and/or incremented based upon the outcome of a game displayed in the first display area (e.g., see FIGS. 5A-5C). Further, display of a jackpot amount associated with the shared number of free spins may be displayed proximate to, but smaller than, the number of free spins to further emphasize to a player that while jackpot amounts may differ based upon wager amount, the number of free spins available to be won is consistent.

In the example embodiment, a shared progressive spin count is stored at the progressive controller and is displayed as the same amount of spins at all electronic gaming devices connected to the progressive controller. Whenever a certain symbol is displayed during an electronic game at one of the electronic gaming devices connected to the progressive controller, the progressive controller may increase a baseline value. The baseline value may be a value generated and stored by the progressive controller and used to determine whether to increase the shared progressive spin count and/or a jackpot amount, and by how much. In other words, the baseline value remains consistent across bet levels, and may be used to determine the shared number of free spins and/or a jackpot associated with the shared spins (e.g., the baseline value may be multiplied based upon a wager value to determine a nominal jackpot amount associated with the shared spins for that wager value).

In response to increasing the baseline value, the progressive controller may be configured to increase the shared progressive amount of spins (e.g., as shown below with respect to Table One). In some embodiments, the progressive controller may increase the shared amount of progressive spins any time a certain symbol is displayed. In some embodiments, the baseline value may need to increase by a threshold amount before the progressive controller increases the shared amount of progressive spins (e.g., the shared amount of progressive spins may be increased each time the baseline value increases by 5 cents, 10 cents, or any predefined threshold/increment). In some embodiments the progressive controller may also increase a jackpot amount in response to the baseline value being increased.

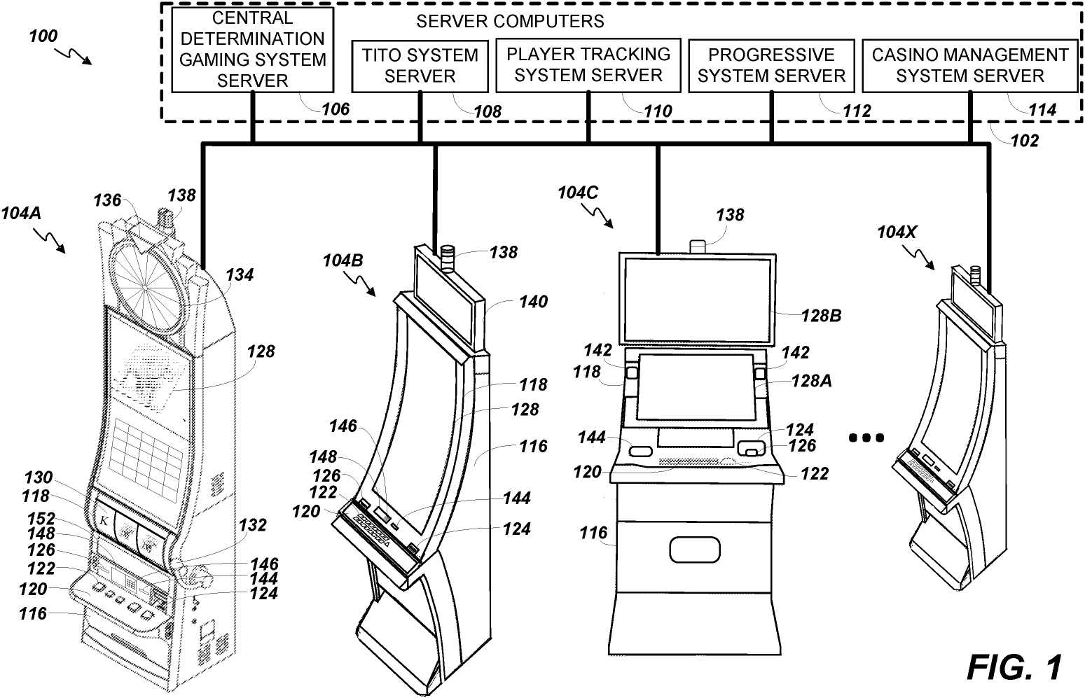

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

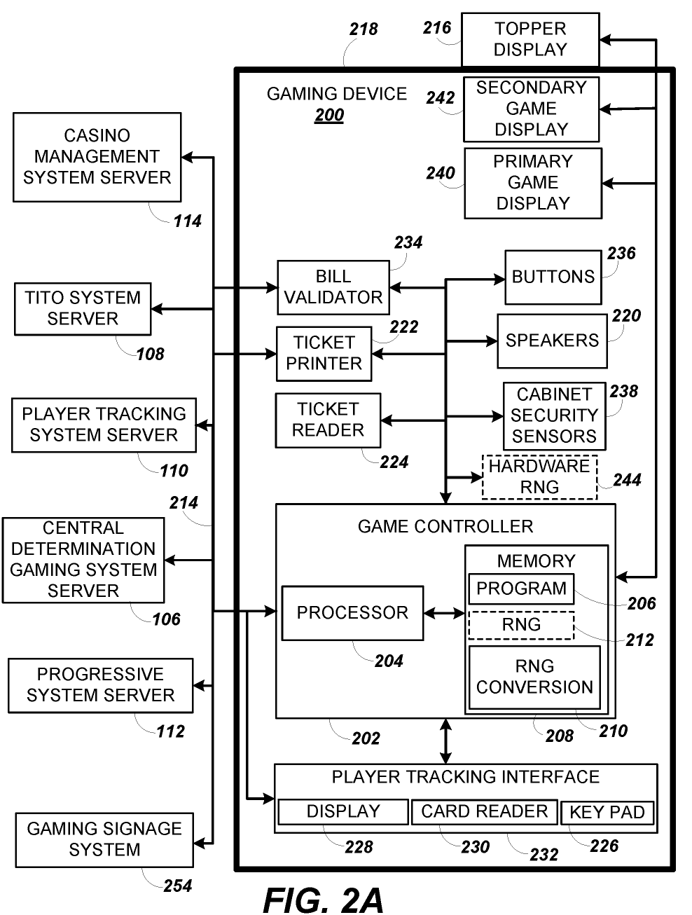

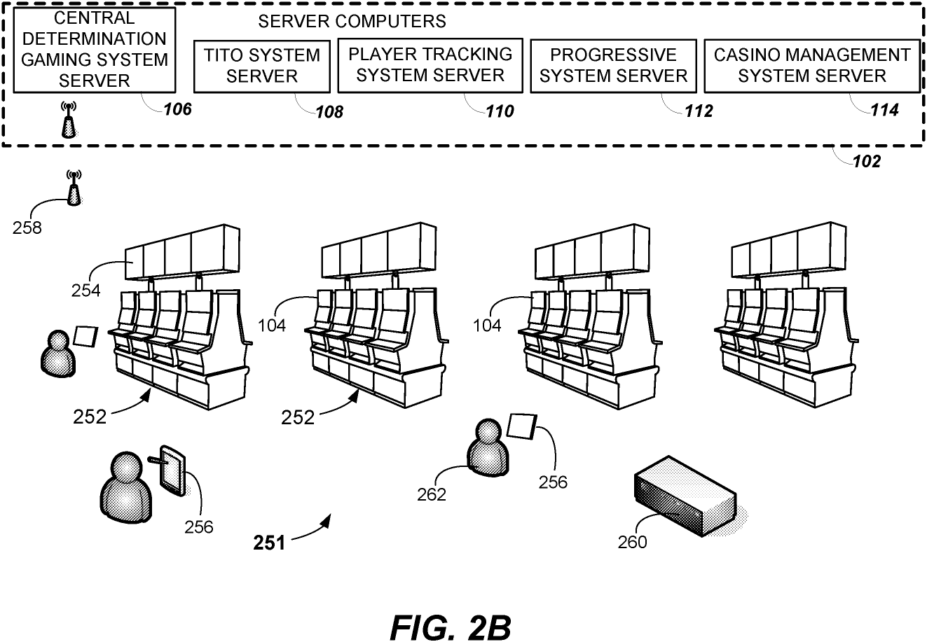

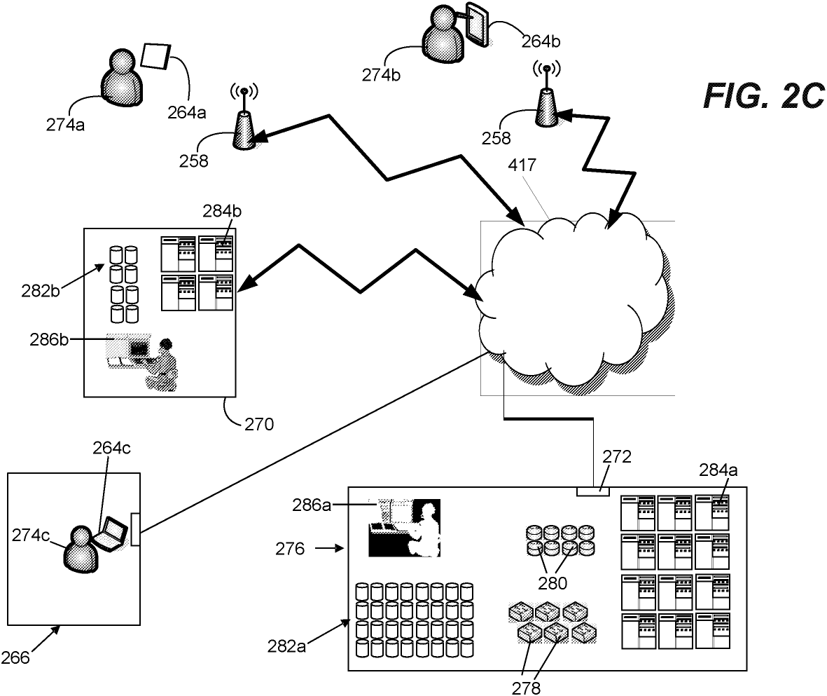

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player’s playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

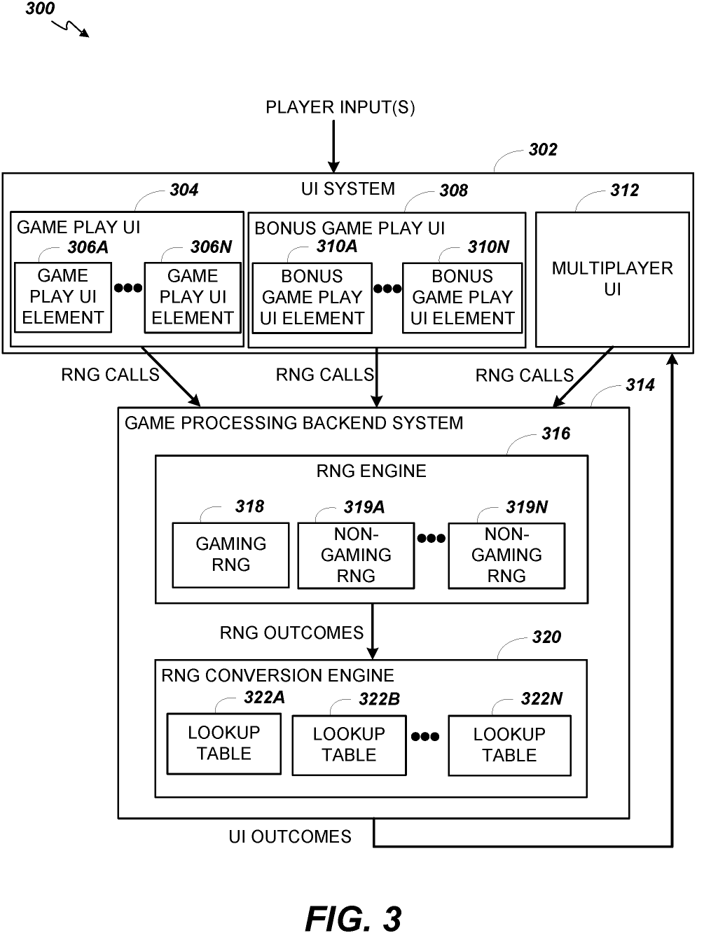

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

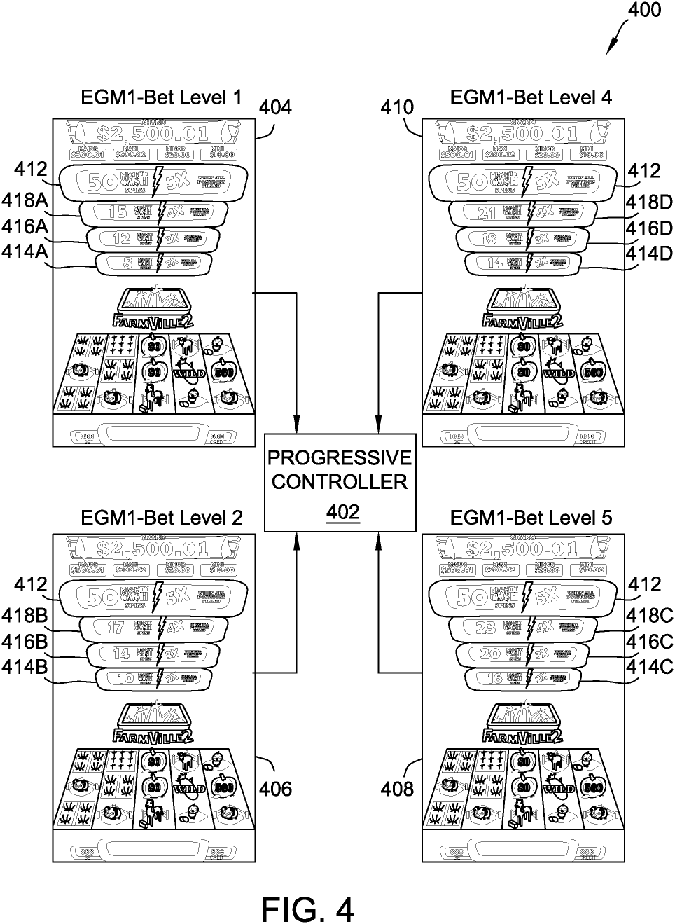

FIG. 4 is an example diagram 400 of a progressive controller 402 in communication with a plurality of electronic gaming devices 404-410 as described herein.

In the example embodiment, progressive controller 402 includes at least one processor and at least one memory device and is in communication with each of devices 404-410 via a network. Progressive controller 402 is configured to control at least one progressive play meter (e.g., a number of shared/linked free spins) that is shared/linked across devices 404-410. In the example shown in FIG. 4, a linked progressive 412 is shown at each of devices 404-410. Linked progressive 412 includes the same number of spins at each device 404-410, may be increased based upon a trigger at any of devices 404-410, and may be presented at any of devices 404-410. Notably, controller 402 is configured to control linked progressive 412 such that progressive 412 is the same at devices 404-410 (e.g., the same amount of free spins are eligible to be presented at each device 404-410) in communication with controller 402.

Additionally, progressive controller 402 may control one or more additional progressive jackpots, such as the grand jackpot, major jackpot, etc. shown on each of the devices 404-410. These jackpots may be based on a coin-in (e.g., these may increment proportionally to a wager/input made at any one of the linked devices 404-410). Additionally, as will be discussed later, certain meters 414A-D, 416A-D, 418A-D and these progressive jackpots may be tied to a wager/bet/input level, whereas the shared/linked progressive 412 play meter is independent of a wager level.

A plurality of feature levels and a plurality of corresponding progressive play meters may be displayed during an electronic game as described herein. The example electronic game in FIGS. 4-6 is illustrated as having a farm theme, where the game symbols display farm-related elements such as horses, pigs, cows, crops, fields, etc. In keeping with this theme, the configurable symbols are represented in this example embodiment by pumpkins. The configurable symbols may include value symbols, jackpot symbols, mystery symbols, and/or repeater symbols.

In FIG. 4, each of devices 404-410 includes progressive play meters 414A-D, 416A-D, 418A-D, different for each device 404-410 (e.g., because of different bet levels and/or different game outcomes at devices 404-410), and a linked progressive 412 that is the same across each device 404-410. Each progressive play meter 414A-D, 416A-D, 418A-D may initially be set to a default number of plays which may be the same number as one or more of the other progressive play meters 414A-D, 416A-D, 418A-D, or may be different than some of the other progressive play meters 414A-D, 416A-D, 418A-D. For example, a configurable symbol that is a jackpot symbol may result in adjusting certain progressive play meters by a particular amount or by particular corresponding amounts, (e.g., incrementing certain progressive play meters by 1).

In FIG. 4, each meter is designated by a different color (e.g., the first or yellow meter 414A-D, the second or green meter 416A-D, the third or blue meter 418A-D, and a fourth or red meter associated with progressive 412 that is shared). As mentioned herein, meters may be incremented (and/or decremented) based on events occurring during play of the electronic game. For example, in some embodiments, the electronic game may include spin award symbols that increment one or more of progressive play meters 414A-D, 416A-D, 418A-D when they appear in an electronic game outcome. In some embodiments, the spin award symbols may be in the form of configurable symbols that can also function to trigger a hold and spin feature game. For example, in certain embodiments, the spin award symbols may be value, jackpot, mystery and/or repeater symbols that include a further designation (e.g., color or other indicia) to indicate that they also function as spin award symbols. In the illustrated embodiment of FIG. 4, the spin award symbols are designated by pumpkins (configurable symbols) with award ribbon indications (“ribboned pumpkins”). In various embodiments, progressive play meters may be incremented (and/or decremented) based on random events, various wager thresholds such as a total amount wagered, etc.

For example, display of a certain color award ribbon at a gaming device may cause the meter 414A-D, 416A-D, 418A-D associated with that color at that particular gaming device to increment by one (e.g., and meters at other gaming device would not increment). However, display of a colored ribbon matching the color of the shared progressive 412 would cause progressive 412 to be incremented at each device in communication with controller 402.

In the example embodiment, progressive 412 is stored at controller 402 and is displayed as the same amount of spins at electronic gaming devices 404-410. Whenever a certain symbol (e.g., a red-ribboned pumpkin) is displayed during an electronic game at one of electronic gaming devices 404-410 connected to progressive controller 402, progressive controller 402 may increase a baseline value (e.g., a value generated and stored by progressive controller 402 and used to determine whether to increase the shared progressive 412 spin count and/or a jackpot amount, and by how much). In response to increasing the baseline value, the controller 402 may be configured to increase the shared progressive 412 amount of spins (e.g., as shown below with respect to Table One). In some embodiments, progressive controller 402 may increase the shared progressive 412 amount of spins any time a certain symbol is displayed at at least one of devices 404-410. In some embodiments, the baseline value may need to increase by a threshold amount before the progressive controller increases the shared progressive 412 amount of spins (e.g., the shared amount of progressive spins may be increased each time the baseline value increases by 5 cents, 10 cents, or any predefined threshold/increment). In some embodiments progressive controller 402 may also increase a jackpot amount (e.g., amount 602) in response to the baseline value being increased.

FIGS. 5A, 5B, and 5C are example screenshots 500, 520, 540, of a sequence of an electronic game including a linked progressive, as described herein. FIG. 5A shows a game outcome after an initiation of a spin of the electronic game (e.g., a base game). A random outcome is determined based on one or more random numbers generated by an RNG (e.g., RNG 318) and a lookup table (e.g., tables 322A-N). The random outcome includes various symbols displayed at the symbol positions in a display matrix 502.

In some embodiments, the appearance of a particular level (e.g., color) spin award symbol in an electronic game outcome causes a respective progressive play meter to be adjusted. For example, in the illustrated embodiment of FIGS. 5A-5C, the color of the ribbon designates the feature level to which a given spin award symbol applies. In particular, a yellow ribboned pumpkin increments the progressive play meter 414A-D for the first (yellow) level at the device where the yellow ribboned pumpkin is displayed, a green ribboned pumpkin increments the progressive play meter 416A-D for the second (green) level at the device where the green ribboned pumpkin is displayed, a blue ribboned pumpkin increments the progressive play meter 418A-D for the third (blue) feature level at the device where the blue ribboned pumpkin is displayed, and a red ribboned pumpkin causes the linked progressive 412 meter at each of the devices 404-410 in communication with controller 402.

In some embodiments, a common symbol may be initially displayed at symbol positions where a ribboned pumpkin will be displayed. For example, a barn may be displayed at each symbol position where a pumpkin will appear. The bam(s) may then disappear, with the appearance of a pumpkin(s) replacing the barns at the symbol positions. In other words, barns or other animations may be displayed at certain symbol positions in a game outcome to attract player attention to those certain symbol positions (e.g., because a pumpkin that may include a credit amount and/or a colored ribbon will appear afterward at those positions).

By way of example, FIG. 5A shows an electronic game outcome in display matrix 502 (e.g., a first display area). The outcome includes three pumpkins (two 80 credit pumpkins and one red ribboned pumpkin 504 associated with a credit value of 560). Display of the red-ribboned pumpkin 504 causes the linked progressive 412 meter to be incremented from 50 spins (see FIG. 5A) to 51 spins (see FIG. 5C) at each device 404-410 in communication with controller 402. As shown through FIGS. 5A-5C, the red ribbon 506 may be displayed initially on pumpkin 504, then as traveling from matrix 502 to the shared progressive meter (e.g., FIG. 5B) to indicate that the shared progressive meter will be incremented (e.g., FIG. 5C).

Ribboned pumpkins other than pumpkin 504 may cause meters 414A-D, 416A-D, 418A-D to be increased only at the device 404-410 where the pumpkin appeared. In some instances, an animation may be shown when incrementing the progressive play meters. For example, a ribbon 506 may be illustrated as moving from the pumpkin in the game outcome to the respective progressive play meter in association with incrementing that progressive play meter (e.g., as shown in FIG. 5B).

In some embodiments, a bonus and/or feature game may be initiated in response to a trigger condition. For example, the trigger condition may include a certain/predetermined number of bonus symbols (pumpkins) being displayed in matrix 502. In the bonus/feature game, a player may be presented a number of free spins corresponding to one of meters/progressives 412, 414A-D, 416A-D, 418A-D. Notably, if the player is presented with the shared number of free spins (e.g., shown at 412), controller 402 or a different controller may determine an outcome of the bonus/feature game based at least in part upon the bet/wager/input level at that particular gaming device. In other words, while the same number of free spins are presented with respect to progressive 412, the total outcome/output of those free spins may vary across bet/wager/input levels in order to control RTP.

Some embodiments may also include symbols that cause one or more of the progressive play meters to decrement. For example, in some embodiments, some spin award symbols may be assigned negative values that cause the associated progressive play meter to decrement. For example, in the implementation of FIGS. 5A-5C, a rotten pumpkin symbol may cause one of the progressive play meters to be decremented or reset to an initial value.

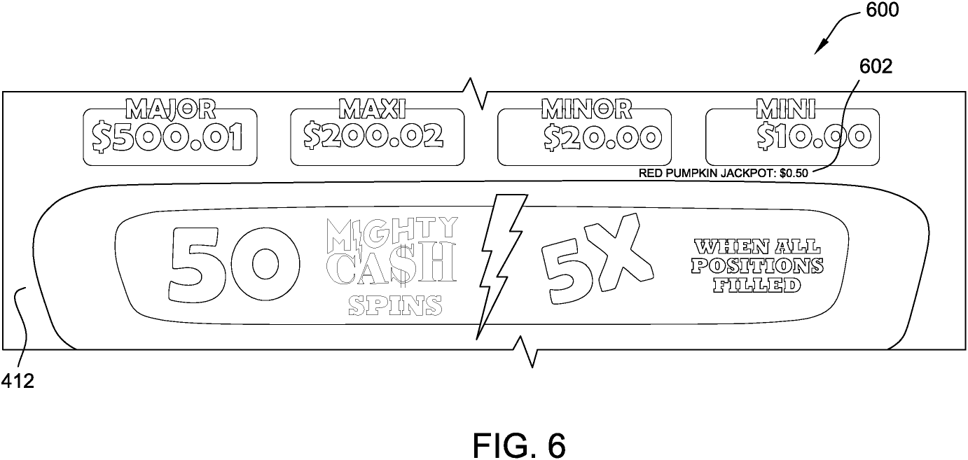

FIG. 6 is an example portion 600 of screenshot 500 shown in FIG. 5A. In some embodiments, a progressive jackpot amount 602 may be associated with linked progressive 412. For example, while a main achievement of progressive 412 is a progressive that is the same at each device in communication with controller 402, certain regulations may require a jackpot amount 602 be associated with linked progressive 412. Accordingly, in some embodiments, a nominal amount (e.g., as shown in FIG. 6) may correspond to progressive jackpot amount 602.

For example, controller 402 may determine that a red ribboned pumpkin 504 is displayed at one of devices 404-410 (e.g., controller 402 may receive a trigger event message from one of the devices 404-410 when a red ribboned pumpkin 504 is displayed). Controller 402 may then cause jackpot amount 602 to increase. Controller 402 may then cause progressive 412 to increase, and cause display of amount 602 and progressive 412. In some embodiments, amount 602 may vary at a device 404-410 depending on a wager/bet placed at the device 404-410. However, and as described elsewhere herein, progressive 412 remains the same at each device 404-410.

In various embodiments, controller 402 may only store a jackpot amount 602 and each device 404-410 may receive an increased jackpot amount 602 from controller 402. Each gaming device 404-410 may then determine the value of progressive 412 based on their respective current bet level and jackpot amount 602. Each gaming device 404-410 may determine the same value of progressive 412 regardless of their bet level.

In the example embodiment, players at devices 404-410 are eligible to win the same output (e.g., same number of spins) regardless of their wager/bet level. An example implementation of controller 402 during five spins of an electronic game is described with respect to Table One (below).

Table One

| Sp in | Bet | Baseline _before | SpinCounter before spin | # Special symbol | Baselin e_Curr ent | SpinCounter _Meter | Jackpot_Inc rease | Jackpot_Met er |
|---|---|---|---|---|---|---|---|---|
| 1 | 80 | 50 | 50 | 1 | 58 | 51 | 8 | 58 |
| 2 | 160 | 58 | 51 | 0 | 58 | 51 | 0 | 116 |
| 3 | 280 | 58 | 51 | 1 | 66 | 52 | 28 | 231 |
| 4 | 360 | 66 | 52 | 0 | 66 | 52 | 0 | 297 |
| 5 | 80 | 66 | 52 | 1 | 74 | 53 | 8 | 74 |

Examples of five different spins are shown in Table One. In this example, controller 402 determines and updates a baseline number (e.g., a number used by controller 402 to determine whether to increase progressive 412 and/or amount 602, and by how much), and using different algorithms in combination with an updated baseline number, determines a number of linked spins to display at progressive 412 and a value of amount 602.

In the example of Table One, special symbols (e.g., red-ribboned pumpkins) are displayed during spins 1, 3, and 5. Accordingly, after spins 1, 3, and 5, controller 402 causes the baseline current value to increase. Based upon the baseline current value increase, controller 402 causes amount 602 to increase at each device in communication with controller 402 and causes progressive 412 to increase at each device in communication with controller 402. For example, as shown in Table One, before spins 2 and 4 (e.g., and 6, not shown), controller 402 causes progressive 412 to increase from 50 to 51 spins, and 51 to 52 spins respectively (e.g., based upon an increase in the baseline current value). In other words, the baseline current value is used by controller 402 and converted via one or more algorithms into progressive 412 number of shared spins and/or amount 602 (e.g., the baseline current value is used by controller 402 to determine whether to increase progressive 412 and/or amount 602, and by how much).

As explained herein, progressive controller 402 may be in communication with plurality of electronic gaming devices 404-410 each displaying a number of linked progressive free spins. The number of linked progressive free spins is associated with a plurality of sets of paytables, and of the plurality of electronic gaming devices 404-410 is eligible to present the number of linked progressive spins during play of an electronic game. Based upon a progressive symbol being displayed at an electronic gaming device of the plurality of electronic gaming devices 404-410, controller 402 causes the number of linked progressive free spins to be increased to an updated number of linked progressive free spins. The updated number of linked progressive spins is then displayed at and is eligible to be presented at each electronic gaming device of the plurality of electronic gaming devices 404-410.

Controller 402 may determine that a trigger condition has been met in an electronic game at an electronic gaming device of the plurality of electronic gaming devices 404-410 wherein the trigger condition corresponds to a feature game wherein the updated number of linked progressive free spins will be presented (e.g., in the example embodiment described herein, the trigger condition may correspond to a predetermined number of pumpkins being displayed in the electronic/base game). The updated number of linked progressive spins are then presented at the electronic gaming device for the feature game. In some embodiments, controller 402 may, based upon presenting the updated number of linked progressive spins, reset the number of linked progressive spins to a predetermined number of linked progressive spins (e.g., 50 spins).

In some embodiments, upon triggering the feature game, a player may be presented with a predetermined number of free spins (e.g., three free spins) that may be reset based upon various trigger conditions during the feature game. In some embodiments, if a feature symbol corresponding to a meter 412-418 is included in one of the predetermined number of symbols that feature the trigger game, the player may be presented with additional free spins corresponding to the meter 412-418 with which the feature symbol corresponds (e.g., a red-ribboned pumpkin would correspond with the number of free spins in the red meter, a blue-ribboned pumpkin corresponds with the number of free spins in the blue meter, etc.).

Further, once the feature game is triggered, controller 402 may determine a wager amount associated with the electronic game and based upon the wager amount, determine a set of paytables of a plurality of sets of paytables (e.g., 322A-N) for the feature game wherein each set of paytables is associated with a different wager amount. Controller 402 may then determine at least one paytable of the set of paytables for the feature game and based upon the at least one paytable, present the updated number of linked progressive spins at the electronic gaming device for the feature game, wherein each spin of the updated number of linked progressive spins is controlled based at least in part upon the at least one paytable to control return to player (RTP) across each different wager amount. For example, the feature game may include symbol positions in matrix 502, or another matrix, to be converted into their own reel wherein each spin includes a spin of each symbol position not already including a pumpkin (e.g., or other feature symbol). Upon completion of the feature game, a player may be presented with a sum of each credit value displayed on a pumpkin in a symbol position. As indicated on at least some of meters 412-418, if each symbol position is filled with a pumpkin including a credit value thereon, each of the credit values may be multiplied by a predetermined amount (e.g., based upon the meter - 5x, 4x, 3x, 2x, etc.).

In some embodiments, selection of a feature game outcome in the at least one paytable may correspond to at least one RNG outcome, the number of free spins being presented during the feature game (e.g., needing to present a certain outcome in a known number of spins), and/or the credit values displayed on feature trigger symbols with the feature game is triggered (e.g., needing to present a certain outcome amount while taking into account currently displayed credit amounts that are known to be presented at the conclusion of the feature game) at least to control RTP.

In some embodiments, a set of progressive play meter values of the plurality of sets of progressive play meter values for a plurality of progressive play meters (e.g., 412-418) may be presented wherein the set of progressive play meter values is associated with the electronic gaming device. Further, each progressive play meter of the plurality of progressive play meters may be associated with a different color. Controller 402 may determine that a colored progressive symbol including a color associated with a progressive play meter of the plurality of progressive play meters is displayed at an electronic gaming device of the plurality of electronic gaming devices 404-410 and, based upon the colored progressive symbol being displayed, increment the progressive play meter value (e.g., the number of free spins) of the progressive play meter.

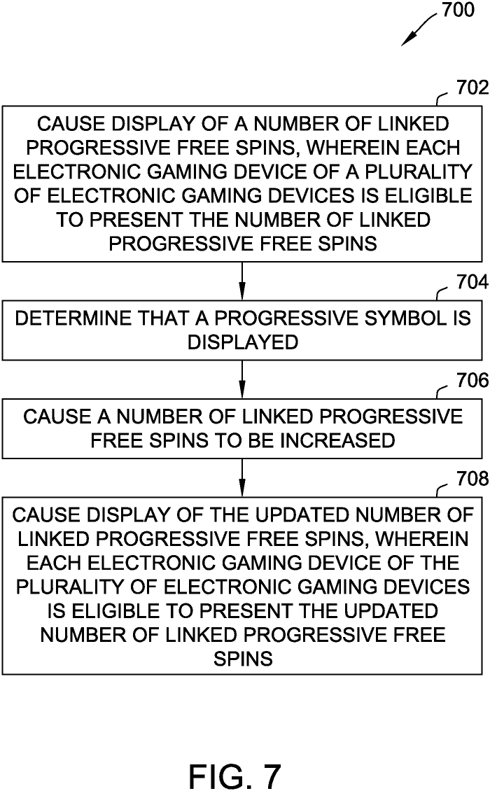

FIG. 7 is an example method 700 of electronic gaming including a linked progressive, as described herein. In the example embodiment, method 700 includes causing display 702 (e.g., transmitting instructions that cause display) of a number of linked progressive free spins (e.g., linked progressive 412) at each electronic gaming device of a plurality of electronic gaming devices (e.g., devices 404-410) wherein the number of linked progressive free spins is stored in at least one memory device and associated with a plurality of sets of paytables stored in the at least one memory device, and wherein each electronic gaming device of the plurality of electronic gaming devices is eligible to present the number of linked progressive free spins during play of an electronic game. In the example embodiment, method 700 also includes determining 704, during the electronic game, that a trigger symbol (e.g., pumpkin 504) is displayed on a display device of at least one electronic gaming device of the plurality of electronic gaming devices and based upon determining that the trigger symbol is displayed, causing 706 the number of linked progressive free spins to be increased to an updated number of linked progressive free spins in the at least one memory device. In the example embodiment, method 700 further includes, based upon the updated number of linked progressive free spins, causing display 708 (e.g., transmitting instructions that cause display) of the updated number of linked progressive free spins at each electronic gaming device of the plurality of electronic gaming devices, wherein each electronic gaming device of the plurality of electronic gaming devices is eligible to present the updated number of linked progressive free spins during play of a feature game.

In some embodiments, method 700 includes determining that a trigger condition has been met in an electronic game at an electronic gaming device of the plurality of electronic gaming devices wherein the trigger condition corresponds to a feature game wherein the updated number of linked progressive free spins will be presented and presenting the updated number of linked progressive free spins at the electronic gaming device for the feature game. In some embodiments, method 700 includes, based upon presenting the updated number of linked progressive free spins, resetting the number of linked progressive free spins in the at least one memory device to a predetermined number of linked progressive spins.

In some embodiments, method 700 includes determining a wager amount associated with the electronic game and, based upon the wager amount, determining a set of paytables of the plurality of sets of paytables for the feature game wherein each set of paytables is associated with a different wager amount. In some embodiments, method 700 includes determining at least one paytable of the set of paytables for the feature game and based upon the at least one paytable, presenting the updated number of linked progressive free spins at the electronic gaming device for the feature game wherein each spin of the updated number of linked progressive free spins is controlled based at least in part upon the at least one paytable to control return to player (RTP) across each different wager amount.

In some embodiments, method 700 includes causing display, at an electronic gaming device of the plurality of electronic gaming devices, of a set of progressive play meter values of the plurality of sets of progressive play meter values for a plurality of progressive play meters, wherein the set of progressive play meter values is associated with the electronic gaming device.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a plurality of electronic gaming devices, wherein each electronic gaming device of the plurality of electronic gaming devices comprises a display device; and
a progressive controller in communication with the plurality of electronic gaming devices, wherein the progressive controller comprises at least one processor and at least one memory device, wherein the at least one memory device includes computer-executable instructions stored thereon that cause the at least one processor to:
cause display of a number of linked progressive free spins at each electronic gaming device of the plurality of electronic gaming devices, wherein the number of linked progressive free spins is stored in the at least one memory device and associated with a plurality of sets of paytables stored in the at least one memory device, and wherein each electronic gaming device of the plurality of electronic gaming devices is eligible to present the number of linked progressive free spins during play of an electronic game;
determine, during the electronic game, that a progressive symbol is displayed on a display device of at least one electronic gaming device of the plurality of electronic gaming devices;
based upon determining that the progressive symbol is displayed, cause the number of linked progressive free spins to be increased to an updated number of linked progressive free spins; and
based upon the updated number of linked progressive free spins, cause display of the updated number of linked progressive free spins at each electronic gaming device of the plurality of electronic gaming devices, wherein each electronic gaming device of the plurality of electronic gaming devices is eligible to present the updated number of linked progressive free spins during play of a feature game.

2. The electronic gaming system of claim 1, wherein the instructions further cause the at least one processor to:
determine that a trigger condition has been met in an electronic game at an electronic gaming device of the plurality of electronic gaming devices, wherein the trigger condition corresponds to a feature game wherein the updated number of linked progressive free spins will be presented; and
present the updated number of linked progressive free spins at the electronic gaming device for the feature game.

3. The electronic gaming system of claim 2, wherein the instructions further cause the at least one processor to, based upon presenting the updated number of linked progressive free spins, reset the number of linked progressive free spins in the at least one memory device to a predetermined number of linked progressive spins.

4. The electronic gaming system of claim 1, wherein the instructions further cause the at least one processor to:
determine a wager amount associated with the electronic game; and
based upon the wager amount, determine a set of paytables of the plurality of sets of paytables for the feature game, wherein each set of paytables is associated with a different wager amount.

5. The electronic gaming system of claim 4, wherein the instructions further cause the at least one processor to:
determine at least one paytable of the set of paytables for the feature game; and
based upon the at least one paytable, present the updated number of linked progressive free spins at an electronic gaming device of the plurality of electronic gaming devices for the feature game, wherein each spin of the updated number of linked progressive free spins is controlled based at least in part upon the at least one paytable to control return to player (RTP) across each different wager amount.

6. The electronic gaming system of claim 1, wherein the instructions further cause the at least one processor to cause display, at an electronic gaming device of the plurality of electronic gaming devices, of a set of progressive play meter values of the plurality of sets of progressive play meter values for a plurality of progressive play meters, wherein the set of progressive play meter values is associated with the electronic gaming device.

7. The electronic gaming system of claim 6, wherein each progressive play meter of the plurality of progressive play meters is associated with a different color, and wherein the instructions further cause the at least one processor to:
determine that a colored progressive symbol comprising a color associated with a progressive play meter of the plurality of progressive play meters is displayed at the electronic gaming device of the plurality of electronic gaming devices; and
based upon the colored progressive symbol being displayed, increment a progressive play meter value of the progressive play meter.

8. A non-transitory computer-readable storage medium with instructions stored thereon that, in response to execution by at least one processor, cause the at least one processor to:
cause display of a number of linked progressive free spins at each electronic gaming device of a plurality of electronic gaming devices, wherein the number of linked progressive free spins is stored in a memory device and associated with a plurality of sets of paytables stored in the memory device, and wherein each electronic gaming device of the plurality of electronic gaming devices is eligible to present the number of linked progressive free spins during play of an electronic game;
determine, during the electronic game, that a trigger symbol is displayed on a display device of at least one electronic gaming device of the plurality of electronic gaming devices;
based upon determining that the trigger symbol is displayed, cause the number of linked progressive free spins to be increased to an updated number of linked progressive free spins in the memory device; and
based upon the updated number of linked progressive free spins, cause display of the updated number of linked progressive free spins at each electronic gaming device of the plurality of electronic gaming devices, wherein each electronic gaming device of the plurality of electronic gaming devices is eligible to present the updated number of linked progressive free spins for play of a feature game.

9. The non-transitory computer-readable storage medium of claim 8, wherein the instructions further cause the at least one processor to:
determine that a trigger condition has been met in an electronic game at an electronic gaming device of the plurality of electronic gaming devices, wherein the trigger condition corresponds to a feature game wherein the updated number of linked progressive free spins will be presented; and
present the updated number of linked progressive free spins at the electronic gaming device for the feature game.

10. The non-transitory computer-readable storage medium of claim 9, wherein the instructions further cause the at least one processor to, based upon presenting the updated number of linked progressive free spins, reset the number of linked progressive free spins in the memory device to a predetermined number of linked progressive spins.

11. The non-transitory computer-readable storage medium of claim 8, wherein the instructions further cause the at least one processor to:
determine a wager amount associated with the electronic game; and
based upon the wager amount, determine a set of paytables of the plurality of sets of paytables for the feature game, wherein each set of paytables is associated with a different wager amount.

12. The non-transitory computer-readable storage medium of claim 11, wherein the instructions further cause the at least one processor to:
determine at least one paytable of the set of paytables for the feature game; and
based upon the at least one paytable, present the updated number of linked progressive free spins at an electronic gaming device of the plurality of electronic gaming devices for the feature game, wherein each spin of the updated number of linked progressive free spins is controlled based at least in part upon the at least one paytable to control return to player (RTP) across each different wager amount.

13. The non-transitory computer-readable storage medium of claim 8, wherein the instructions further cause the at least one processor to cause display, at an electronic gaming device of the plurality of electronic gaming devices, of a set of progressive play meter values of the plurality of sets of progressive play meter values for a plurality of progressive play meters, wherein the set of progressive play meter values is associated with the electronic gaming device.

14. The non-transitory computer-readable storage medium of claim 13, wherein each progressive play meter of the plurality of progressive play meters is associated with a different color, and wherein the instructions further cause the at least one processor to:
determine that a colored trigger symbol comprising a color associated with a progressive play meter of the plurality of progressive play meters is displayed at the electronic gaming device of the plurality of electronic gaming devices; and
based upon the colored trigger symbol being displayed, increment a progressive play meter value of the progressive play meter.

15. A method of electronic gaming implemented by at least one processor in communication with at least one memory device, the method comprising:
causing display of a number of linked progressive free spins at each electronic gaming device of a plurality of electronic gaming devices, wherein the number of linked progressive free spins is stored in the at least one memory device and associated with a plurality of sets of paytables stored in the at least one memory device, and wherein each electronic gaming device of the plurality of electronic gaming devices is eligible to present the number of linked progressive free spins during play of an electronic game;
determining, during the electronic game, that a trigger symbol is displayed on a display device of at least one electronic gaming device of the plurality of electronic gaming devices;
based upon determining that the trigger symbol is displayed, causing the number of linked progressive free spins to be increased to an updated number of linked progressive free spins in the at least one memory device; and
based upon the updated number of linked progressive free spins, causing display of the updated number of linked progressive free spins at each electronic gaming device of the plurality of electronic gaming devices, wherein each electronic gaming device of the plurality of electronic gaming devices is eligible to present the updated number of linked progressive free spins during play of a feature game.

16. The method of claim 15, further comprising:
determining that a trigger condition has been met in an electronic game at an electronic gaming device of the plurality of electronic gaming devices, wherein the trigger condition corresponds to a feature game wherein the updated number of linked progressive free spins will be presented; and
presenting the updated number of linked progressive free spins at the electronic gaming device for the feature game.

17. The method of claim 15, further comprising, based upon presenting the updated number of linked progressive free spins, resetting the number of linked progressive free spins in the at least one memory device to a predetermined number of linked progressive spins.

18. The method of claim 15, further comprising:
determining a wager amount associated with the electronic game; and
based upon the wager amount, determining a set of paytables of the plurality of sets of paytables for the feature game, wherein each set of paytables is associated with a different wager amount.

19. The method of claim 18, further comprising:
determining at least one paytable of the set of paytables for the feature game; and
based upon the at least one paytable, presenting the updated number of linked progressive free spins at an electronic gaming device of the plurality of electronic gaming devices for the feature game, wherein each spin of the updated number of linked progressive free spins is controlled based at least in part upon the at least one paytable to control return to player (RTP) across each different wager amount.

20. The method of claim 15, further comprising causing display, at an electronic gaming device of the plurality of electronic gaming devices, of a set of progressive play meter values of the plurality of sets of progressive play meter values for a plurality of progressive play meters, wherein the set of progressive play meter values is associated with the electronic gaming device.
